(19) United States
(12) Patent Application Publication
(10) Pub. No.: US 2013/0185020 A1
(43) Pub. Date: Jul. 18, 2013

(54) FAULT DETECTION METHODS

(71) Applicant: Richard Ian Stephens, Warwickshire (GB)

(72) Inventor: Richard Ian Stephens, Warwickshire (GB)

(73) Assignee: Converteam Technology Ltd., Rugby (GB)

(21) Appl. No.: 13/514,200

(22) PCT Filed: Dec. 16, 2010
(86) PCT No.: PCT/EP10/07716

§ 371 Date: Aug. 22, 2012

(30) Foreign Application Priority Data
Dec. 21, 2009 (EP) 09015817.1

(51) Int. Cl. G01C 21/16; G06F 11/00

(52) U.S. Cl. CPC G01C 21/16; G06F 11/00
USPC 702/182

(57) ABSTRACT

A fault detection method uses inertial measurements provided by an inertial measurement unit (IMU) (2) to detect faults in position measurement equipment (PME) (4). The method uses at least one inertial measurement (a(t−N) . . . a(t)) to derive at least one unaided marine vessel state estimate (x(t−N) . . . x(t)) in an unaided solution function block (12). This is then compared with at least one position measurement (p(t−N) . . . p(t)) provided by the PME (4) in a fault detection function block (14) to determine if there is a fault in the PME. An earlier inertial measurement (a(t−N+1)) and an earlier position measurement (p(t−N+1)) are used to derive an aided marine vessel state estimate (x′(t−N+1)) in an aided solution function block (10). The aided marine vessel state estimate (x′(t−N+1)) is used as a start condition to the step of deriving the at least one unaided marine vessel state estimate (x(t−N) . . . x(t)). The aided and unaided solution function blocks (10, 12) can be implemented as a Kalman filter.

### TECHNICAL FIELD

The present invention relates to fault detection methods, and in particular to methods where an inertial navigation system (INS) can be used to detect faults in position measurement equipment (PME) that provide position measurements and/or velocity measurements. The PME can be used for the dynamic positioning (DP) of marine vessels, i.e. the use of thrusters to maintain the position of a vessel in the vicinity of a reference point and stabilise its heading, in opposition to environmental forces such as wind and current.

The term “inertial navigation system (INS)” is intended to include systems that contain an inertial measurement unit (IMU), which is normally a lower-level measurement system with an internal or external data fusion algorithm.

The term “dynamic positioning (DP) system” is intended to include other positioning systems for vessels such as position mooring systems and thruster-assisted mooring systems which combine aspects of a DP system with a mooring system.

### BACKGROUND ART

The fundamental components of a dynamic positioning (DP) system are: one or more position reference systems to measure the vessel position and heading; thrusters to apply control action; and a controller to determine the required thrusts. The object of a DP system is not to hold the vessel absolutely stationary, but to maintain its station within acceptable limits. The magnitude of the permitted position variation is dependent upon the application and on operational concerns. In many applications a loss of position beyond the acceptable limits may have a severe impact either on the safety of personnel or equipment, or on the environment. It is vital, therefore, that adequate measurements are taken to maintain the integrity of the DP system as far as is reasonably possible.

Safe operation in DP relies upon accurate measurement of the vessel position and heading at all times. In order to ensure that this is true, even under fault conditions, all measurement systems include redundancy. Physical redundancy requires the replication of equipment to ensure that a single failure of any piece of equipment will not result in complete failure of the overall system and allows faulty equipment to be by-passed using the redundant hardware. The parallel redundant systems must be independent, i.e. no single failure mode should be capable of disabling the overall system.

The DP system combines all available measurements of position, from whatever source, into a single estimate of vessel position. The algorithm for combining the position measurements can be based on a Kalman filter.

The sources of position measurements can include a wide variety of position measurement equipment (PME) such as gyrocompasses (which offer compact, reliable and accurate measurement of vessel heading (yaw), independent of outside disturbances), taut wires, satellite navigation systems (which include global positioning systems (GPS) and differential GPS (DGPS)), inertial navigation systems (INS), and hydro-acoustic positioning systems. The PME could also be a system that provides velocity measurement e.g. a Doppler velocity log (DVL).

An INS uses acceleration measurements to estimate the motion of a vessel in an inertial reference frame. A typical INS will include an inertial measurement unit (IMU) containing a cluster of sensors such as accelerometer and gyros that sense linear acceleration (typically in three orthogonal directions) and rotation rates, respectively. The acceleration measurements provided by the IMU are normally processed to compensate for sensor errors and gravity and are then integrated twice to provide an estimate of velocity and position. The inherent noise in the acceleration measurements and other inaccuracies result in unavoidable drift of the position estimates provided by the INS. A position estimate that is based solely on an INS is sometimes referred to as an “unaided” position estimate because of the unavoidable drift.

It is therefore usual for the drift to be compensated by combining the INS position estimates with independent position measurements provided by another PME unit. Typically, a Kalman filter is used to combine the position estimates from the INS and the position measurements from the other PME in order to identify and maintain an estimate of offsets and drifts in the accelerometers and gyros. Such an arrangement is often referred to as “PME aided INS” because it provides an “aided” position estimate where the drift is at least partially compensated for. The Kalman filter maintains an estimate of the state of the marine vessel which includes at least the vessel's position and velocity and possibly other data such as offsets or drifts in the accelerometers and gyros within the IMU.

The likely drift of position estimates during periods when the position estimates provided by the INS are not being compensated (e.g. because of PME outage or failure) has been determined experimentally in “Integration of an inertial navigation system and DP” by Stephens, R. I, Cretollier, F., Morvan, P.-Y., and Chamberlain, A. G., Dynamic Positioning Conference, 7-8 Oct. 2008, Houston, Tex., United States of America. The drift after about 60 seconds is likely to be less than about 2 metres, and the drift after 120 seconds is likely to be less than about 5 metres. This suggests that an INS can be used to provide unaided position estimates for short periods without the need for any sort of drift compensation.

It can be difficult to detect faults in PME. Various different methods are known including median checks, step detection and noise detection. However, the most reliable method for fault detection relies on having multiple PME units to allow a comparison of different position measurements. When the DP system uses only one or two PME units then the methods for fault detection are limited. For example, with only two PME units available then a drift can be detected but the faulty PME cannot be identified without further information.

There is therefore a need for an improved fault detection system for PME units. Such an improved fault detection system could be used in a DP system where reliability is extremely important such as for drilling vessels, shuttle tankers and supply vessels.

### SUMMARY OF THE INVENTION

The present invention is directed to a method of using the inertial measurements from an inertial measurement unit (IMU) to detect the presence of a fault in one or more position measurement equipment (PME) that would typically form part of a dynamic positioning (DP) system. The IMU may form part of an inertial navigation system (INS). In a preferred fault detection method the inertial measurements from the IMU are stored and used to derive independent “unaided” marine vessel state estimates on the basis that the PME was operating correctly at some previous time and that any short term drift in the unaided marine vessel state estimates is small compared to the error or discrepancy that is to be detected. As used herein, the term “marine vessel state estimate” is intended to refer to an estimate of the physical state of the marine vessel and will include at least the position and velocity of the marine vessel, together with optional data such as offsets or drifts in the accelerometers and gyros within the IMU.

More particularly, the present invention provides a method of using inertial measurements provided by an IMU to detect a fault in PME associated with a marine vessel and providing position measurements and/or velocity measurements, the method comprising the steps of: using an earlier inertial measurement and one or both of an earlier position measurement and an earlier velocity measurement to derive an aided marine vessel state estimate; using at least one inertial measurement and the aided marine vessel state estimate as a start condition to derive at least one unaided marine vessel state estimate; and comparing the at least one unaided marine vessel state estimate with at least one position measurement and/or at least one velocity measurement provided by the PME to determine if there is a fault in the PME.

The aided and unaided marine vessel state estimates will typically be in the form of a vector having at least a position component that represents an estimate of vessel position and a velocity component that represents an estimate of vessel velocity or speed. It will be readily appreciated that a Kalman filter or other state observer will naturally provide such a vector with both position and velocity components regardless of the measurements it receives from the PME and/or the IMU. The position component will typically contain at least two elements or entries in the vector, a North position and an East position, although the position component could be stored and/or measured in any other suitable coordinate system. Similarly, the velocity component will typically include at least two elements or entries in the vector, a North velocity and an East velocity, but measured in surge/sway velocity (i.e. measured in ship coordinates). Any comparison between an unaided marine vessel state estimate and at least one position measurement and/or at least one velocity measurement provided by the PME to determine if there is a fault in the PME may therefore involve some sort of conversion or transformation from one coordinate system to another.

Further information regarding the normal operation of Kalman filters for position and velocity estimation can be found from Gelb, A., Applied Optimal Estimation, MIT Press, 1974 and Astrom, K. J. and Wittenmark, B., Computer-controlled Systems: Theory and Design, second edition, Prentice-Hall, 1990.

If there is a fault in the PME then this will result in an error or discrepancy between the at least one position measurement and/or at least one velocity measurement and the corresponding component(s) of the at least one unaided marine vessel state estimate. The detection of an error or discrepancy can therefore be used to check if the PME is operating properly or not.

The fault detection method assumes: (i) that at some previous time (e.g. N+1 seconds ago) the PME was operating properly such that the position measurement and/or velocity measurement provided by the PME at that previous time (e.g. at t−(N+1) seconds) was error-free, and (ii) that the drift in the inertial measurements provided by the IMU since that previous time (e.g. for the last N+1 seconds) is small compared to the error or discrepancy to be detected. The larger the value of N the better the discrimination of faults such as drift. For example, with a linear drift rate of r metres per second the residual will be N·r metres so making the value of N larger improves the noise rejection. The practical value of N that can be used depends on the quality of the IMU, the required fault detection rate etc. For a typical IMU it is expected that a value of N=60 seconds could be used to detect errors of perhaps 6 metres or more.

The inertial measurements provided by the IMU will normally include linear accelerations (typically in three orthogonal directions) and rotation rates. These can be combined to form an acceleration vector a(t). Position measurements p(t) provided by the PME can be in the form of spatial coordinates or absolute position on the earth, for example. Velocity measurements provided by the PME can be in the form of a Doppler velocity log (DVL), for example. The IMU and PME will provide measurements at any suitable update rate, for example once a second.

Measurements provided by the IMU and PME are preferably stored in separate buffers. If more than one PME is used then each will typically have its own buffer for storing its respective measurements.

In a typical example an acceleration vector might be added to an acceleration buffer once every second so that after N+1 seconds the acceleration buffer would include N+1 acceleration vectors. If the PME provides position measurements then after N+1 seconds a position buffer would include N+1 position measurements. If the PME provides velocity measurements (either in addition to, or instead of, position measurements) then after N+1 seconds a velocity buffer would include N+1 velocity measurements. Each buffer will normally hold a maximum of N+1 acceleration vectors or PME measurements. The buffers can be filled during a preliminary or start-up process during which no fault detection normally takes place or preset to an arbitrary initial value (e.g. zero). Once the buffers are full then as subsequent acceleration vectors and measurements are provided by the IMU and PME, respectively, the oldest acceleration vectors and measurements are simply discarded from the buffers. During normal operation of the fault detection method each buffer will therefore typically contain the most recent acceleration vectors and measurements in the form of a(t−(N+1)), a(t−N) . . . a(t−1), a(t) and, in the case of position measurements, p(t−(N+1)), p(t−N) . . . p(t−1), p(t), for example.

An earlier inertial measurement provided by the inertial measurement unit (e.g. for a time t−(N+1)) is combined with one or both of an earlier position measurement and an earlier velocity measurement provided by the PME (e.g. for a time t−(N+1)) to derive the “aided” marine vessel state estimate. The aided marine vessel state estimate is then used as a start condition to derive the at least one unaided marine vessel state estimate as described in more detail below. It will be readily appreciated that the use of one or both of an earlier position measurement and an earlier velocity measurement will depend on what PME measurements are available and the configuration of the particular fault detection system.

At each iteration of the fault detection method (typically once every second) the following steps are preferably carried out for a time t:
1. An aided marine vessel state estimate for time t−(N+1) (e.g. x′(t−(N+1))) for that iteration is derived by combining an inertial measurement for time t−(N+1) (e.g. acceleration vector a(t−(N+1))) and one or both of a position measurement and a velocity measurement for time t−(N+1) (e.g. position measurement p(t−(N+1))).
2. The aided marine vessel state estimate for t−(N+1) (e.g. x′(t−(N+1))) is used as a start condition to a process that derives the at least one unaided marine vessel state estimate from stored inertial measurements for time t−N to time t (e.g. the buffered acceleration vectors a(t−N) . . . a(t−1), a(t)).

For example, using the aided marine vessel state estimate x′(t−(N+1)) as a start condition the process may derive a first unaided marine vessel state estimate x(t−N) from the acceleration vector a(t−N); a second unaided marine vessel state estimate x(t−(N−1)) from the acceleration vector a(t−(N−1)); a third unaided marine vessel state estimate x(t−(N−2)) from the acceleration vector a(t−(N−2)); and so on until a final unaided marine vessel state estimate x(t) is derived from the acceleration vector a(t). In other words, for each iteration the buffered acceleration vectors a(t−N) . . . a(t−1), a(1) can be used to derive a series of unaided marine vessel state estimates x(t−N) . . . x(t−1), x(t) for all time steps between t−N and t. The aided marine vessel state estimate that is used as a start condition is derived from one or both of an earlier position measurement and an earlier velocity measurement provided by the PME (e.g. for a time t−(N+1)). It will therefore be readily appreciated that for each iteration of the fault detection method the buffered position measurement and/or velocity measurement and acceleration vector for time t−(N+1) are used to derive the aided marine vessel state estimate while the remaining buffered acceleration vectors for all time steps between t−N and t are used to derive the series of unaided marine vessel state estimates x(t−N) . . . x(t−1), x(t). The processing of the buffered measurements and acceleration vectors to derive the series of unaided marine vessel state estimates will be completed in a time that is less than the iteration rate of the fault detection method.

The aided marine vessel state estimate x′(t−(N+1)) is preferably used as a start condition to derive the first marine vessel state estimate x(t−N) and the process to derive each subsequent unaided marine vessel state estimate may make use of the previously derived unaided marine vessel state estimate.

The fault detection method may make use of all or part of the series of unaided marine vessel state estimates or just one of the unaided marine vessel state estimates (e.g. x(t)).

The step of comparing the at least one unaided marine vessel state estimate with at least one position measurement and/or at least one velocity measurement provided by the PME to determine if there is a fault in the PME may be implemented in many different ways and may make use of all or part of the buffered measurements (e.g. the buffered position measurements p(t−N) . . . p(t−1), p(t)) or just one of the buffered measurements (e.g. the buffered position measurement p(t)). For example, if each iteration of the fault detection method provides one unaided marine vessel state estimate for time t (e.g. x(t)) then this can be compared directly with at least one measurement for time t that is provided by the PME (e.g. the position measurement p(t)). If the error between the corresponding component of the unaided marine vessel state estimate x(t) and the at least one measurement provided by the PME exceeds a particular threshold then the particular iteration might be flagged to indicate the possibility of a fault. For example, if the PME provides position measurements then the position component of the unaided marine vessel state estimate x(t) can be compared against the position measurement p(t) and a particular iteration might be flagged if the error exceeds a particular threshold, say m metres, for example. Similarly, if the PME provides only velocity measurements, e.g. in the form of a Doppler velocity log, then the velocity component of the unaided marine vessel state estimate x(t) can be compared against the velocity measurement and a particular iteration might be flagged if the error exceed a particular threshold, say p metres/second, for example. Flagged iterations may be monitored using a suitable algorithm to try and avoid false error determinations. For example, the fault detection method may look for a certain number of consecutive flagged iterations or a certain number of flagged iterations in a certain period of time before a final fault determination is made. An alternative is to compare all or part of the series of unaided marine vessel state estimates for time t−N to time t (e.g. x(t−N) . . . x(t−1), x(t)) against the series of position measurements and/or velocity measurements for time t-N to time t (e.g. the buffered position measurements p(t−N) . . . p(t−1), p(t)) using some sort of mathematical algorithm. Each iteration would therefore make use of all or part of the position measurements and/or velocity measurements for the previous N seconds.

Other possible fault detection techniques might look for discontinuities or particular variations (e.g. step changes) in the distribution of the error between all or part of the series of unaided marine vessel state estimates and all or part of the series of position measurements and/or velocity measurements over time.

The unaided marine vessel state estimates provided by each iteration of the fault detection method can also be stored or buffered and combined using any suitable mathematical algorithm before being used to determine if there is a fault in the PME.

The aided and unaided marine vessel state estimates are preferably derived using a recursive algorithm such as a Kalman filter. For both the aided and unaided marine vessel state estimates it is important to note that the recursive algorithm uses inertial measurements provided by the IMU (e.g. linear accelerations and rotation rates that can be combined to form an acceleration vector a(t)) to derive an estimate of position. A preliminary step might therefore include deriving an inertial solution in the form of position and velocity estimates from the inertial measurements. If the PME provides only velocity measurements then, at some point after switching on the fault detection system and before starting the fault detection method, the Kalman filter or other state observer needs at least one position measurement to set up or initialise its position estimate. This position measurement might come from another PME or from an operator typing it in, for example. It will be readily appreciated that once the Kalman filter has been initialised no further position measurements are needed since an estimate of position (i.e. a position component for the vector) can be derived from velocity measurements provided by the PME and/or the inertial measurements provided by the IMU.

The at least one unaided marine vessel state estimate can be compared with at least one position measurement and/or at least one velocity measurement provided by a single PME. For example, the fault detection method can rely on position measurements and/or velocity measurements from a single PME such as a satellite navigation system (e.g. GPS and differential GPS (DGPS)). However, it is also possible to provide an alternative inertial navigation architecture with two or more PME located in parallel and associated with the marine vessel. In this case the fault detection method may derive separate aided and unaided marine vessel state estimates for each PME in the manner described above. Alternatively, the aided marine vessel state estimate for each iteration of the fault detection method may be derived by using the earlier position measurement and/or the earlier velocity measurement provided by one or more of the PME. Different combinations of PME could be selected for the derivation of the aided marine vessel state estimate by appropriate switching between position and velocity measurements using a switch array and switch controller. The aided marine vessel state estimate for each iteration may also be derived from a combination (e.g. a weighted combination or average) of the earlier position measurements and/or the earlier velocity measurements provided by two or more of the PME. Fault detection may be applied to one or more of the PME, and any PME that is checked for faults need not necessarily be the one whose earlier position measurements and/or earlier velocity measurements are used to derive the aided marine vessel state estimates. In other words, for each iteration of the fault detection method a first PME can provide an earlier position measurement and/or an earlier velocity measurement that is used to derive the aided marine vessel state estimate while a second PME can provide at least one position measurement and/or at least one velocity measurement to be compared with the at least one unaided marine vessel state estimate to determine if there is a fault in the second PME.

The fault detection method may be used as part of a DP system for a marine vessel. In this case, the inertial measurements provided by the IMU (or position and/or velocity estimates provided by an INS that incorporates the IMU) and position and/or velocity measurements provided by the PME may also be combined in a separate process to derive an estimate of the position or speed of the marine vessel.

The present invention further provides a fault detection system (or inertial navigation architecture) comprising: an IMU providing inertial measurements; at least one PME associated with a marine vessel and providing position measurements and/or velocity measurements; means for deriving an aided marine vessel state estimate using an earlier inertial measurement and one or both of an earlier position measurement and an earlier velocity measurement; means for deriving at least one unaided marine vessel state estimate using at least one inertial measurement and the aided marine vessel state estimate as a start condition; and means for comparing the at least one unaided marine vessel state estimate with at least one position measurement and/or at least one velocity measurement provided by the PMU to determine if there is a fault in the PMU.

Separate buffers may be provided to store inertial measurements provided by the IMU and the position measurements and/or velocity measurements provided by the PME.

The means for deriving at least one unaided marine vessel state estimate and the aided marine vessel state estimate is preferably a Kalman filter. More particularly, the unaided and aided marine vessel state estimates may be derived by a single Kalman filter or by separate Kalman filters running in parallel.

The fault detection system may be adapted or configured to implement the fault detection method described in more detail above.

### DRAWINGS

FIG. 1 is a schematic drawing showing the overall architecture for a first fault detection system according to the present invention with a single position measurement;

FIG. 2 is a schematic drawing showing the contents of the aided solutions function block of FIG. 1;

FIG. 3 is a schematic drawing showing how the unaided solutions for time t−N to time t are determined in sequence for each iteration of the fault detection method;

FIG. 4 is a schematic drawing showing the contents of one of the unaided solution function blocks of FIG. 3;

FIG. 5 is a graph on which the errors between unaided marine vessel state estimates and respective position measurements are plotted over a period of time;

FIG. 6 is a schematic drawing showing the overall architecture for a second fault detection system according to the present invention with first and second position measurement equipment (PME) units, both first and second PME providing position measurements in parallel to derive separate aided marine vessel state estimates for each iteration and for fault detection;

FIG. 7 is a schematic drawing showing the overall architecture for a third fault detection system according to the present invention with first and second PME units, the first and second PME providing position measurements that are combined to derive an aided marine vessel state estimate for each iteration and where the position measurements provided by the first PME only are used for fault detection;

FIG. 8 is a schematic drawing showing the overall architecture for a fourth fault detection system according to the present invention with first and second PME units, the first PME providing a position measurement to derive an aided marine vessel state estimate for each iteration and the second PME providing position measurements for fault detection.

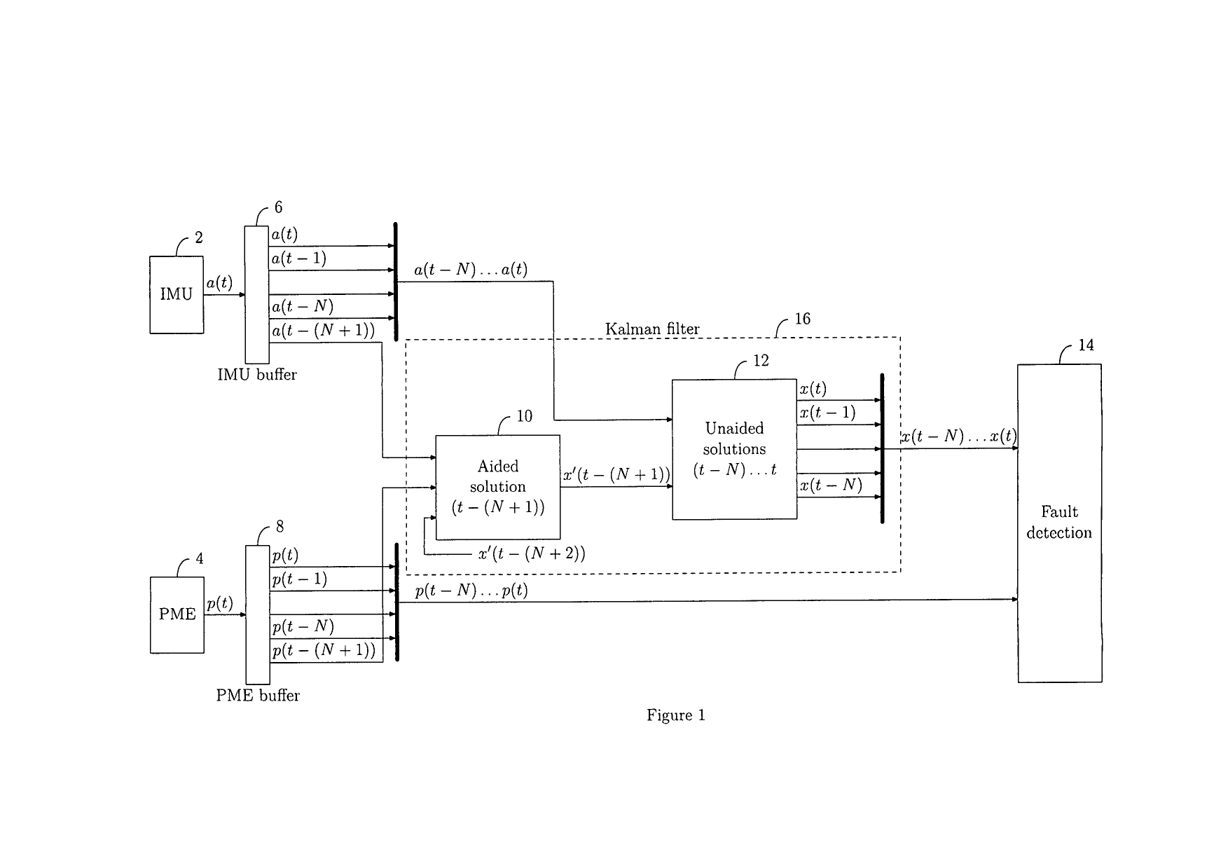

With reference to FIG. 1 a first fault detection system includes an inertial measurement unit (IMU) 2 that can form part of an inertial navigation system (INS). The IMU 2 contains a cluster of sensors such as accelerometers and gyros that sense linear acceleration (typically in three orthogonal directions) and rotation rates, respectively. The inertial measurements provided by the IMU 2 for a time t are combined to form an acceleration vector a(t).

Position measurements can be provided by any suitable position measurement equipment (PME) 4 such as a GPS receiver. Position measurements p(t) provided by the PME 4 for a time t can be in the form of spatial coordinates or absolute position on the earth for example. Although the following description refers to position measurement only, it will be readily appreciated that the PME might also provide velocity measurements (e.g. in the form of a Doppler velocity log (DVL)) either instead of, or in addition to, the position measurements. In this case the fault detection system would be configured to compare these velocity measurements with the velocity component of unaided marine vessel state estimates. It would also be necessary to provide at least one position measurement to the Kalman filter 16 (see below) to set up or initialise its position estimate. If the position measurement cannot be provided by another PME then it can be manually entered by an operator.

The IMU 2 and PME 4 form part of a dynamic position (DP) system for a marine vessel.

An acceleration vector and position measurement is provided by the IMU 2 and PME 4 each second and stored in buffers. More particularly, the acceleration vectors for a time t−(N+1) to time t are stored in an IMU buffer 6 and the position measurements for a time t−(N+1) to time t are stored in a PME buffer 8. In other words, if N=60 seconds then each buffer will store a total of 61 separate acceleration vectors and position measurements provided by the IMU 2 and the PME 4 over the preceding 61 seconds. In practice the acceleration vectors and position measurements provided by the IMU 2 and PME 4 might arrive at different rates so the fault detection system will usually have some way of synchronising the measurements. This might involve ignoring any additional measurements or averaging measurements over the particular period of time. There will also usually be some way of dealing with missing measurements from either the IMU 2 or PME 4, perhaps by assuming that any missing measurement is the same as the previous one.

The buffers 6, 8 may be filled sequentially with acceleration vectors and position measurements during a preliminary or start-up process during which no fault detection would normally take place. Alternatively, the buffers may be preset to an arbitrary value (e.g. zero). Once the buffers 6, 8 are full then as subsequent acceleration vectors and position measurements are provided by the IMU 2 and PME 4 each second the oldest acceleration vectors and position measurements are simply discarded from the buffers. During normal operation of the fault detection method each buffer 6, 8 will therefore contain the most recent acceleration vectors and position measurements in the form of a(t−(N+1)), a(t−N) . . . a(t−1), a(t) and p(t−(N+1)), p(t−N) . . . p(t−1), p(t) for a time t−(N+1) to time t.

The fault detection method runs as a number of iterations. In this example an iteration takes place every second but it will be readily appreciated that other iteration rates can be used.

For an iteration at time t then the following steps are carried out:
1. An aided marine vessel state estimate x′(t−(N+1)) including at least an estimate of the position and velocity of the marine vessel (i.e. having a position and a velocity component) is derived in an aided solution function block 10;
2. A series of unaided marine vessel state estimates x(t−N) . . . x(t−1), x(t) each including at least an estimate of the position and velocity of the marine vessel (i.e. having a position and a velocity component) are derived in an unaided solution function block 12; and
3. The position component of an unaided marine vessel state estimate x(t) is compared to a position measurement p(t) in a fault detection function block 14 to determine if the PME 4 is operating properly.

The aided and unaided solution function blocks form part of a Kalman filter 16.

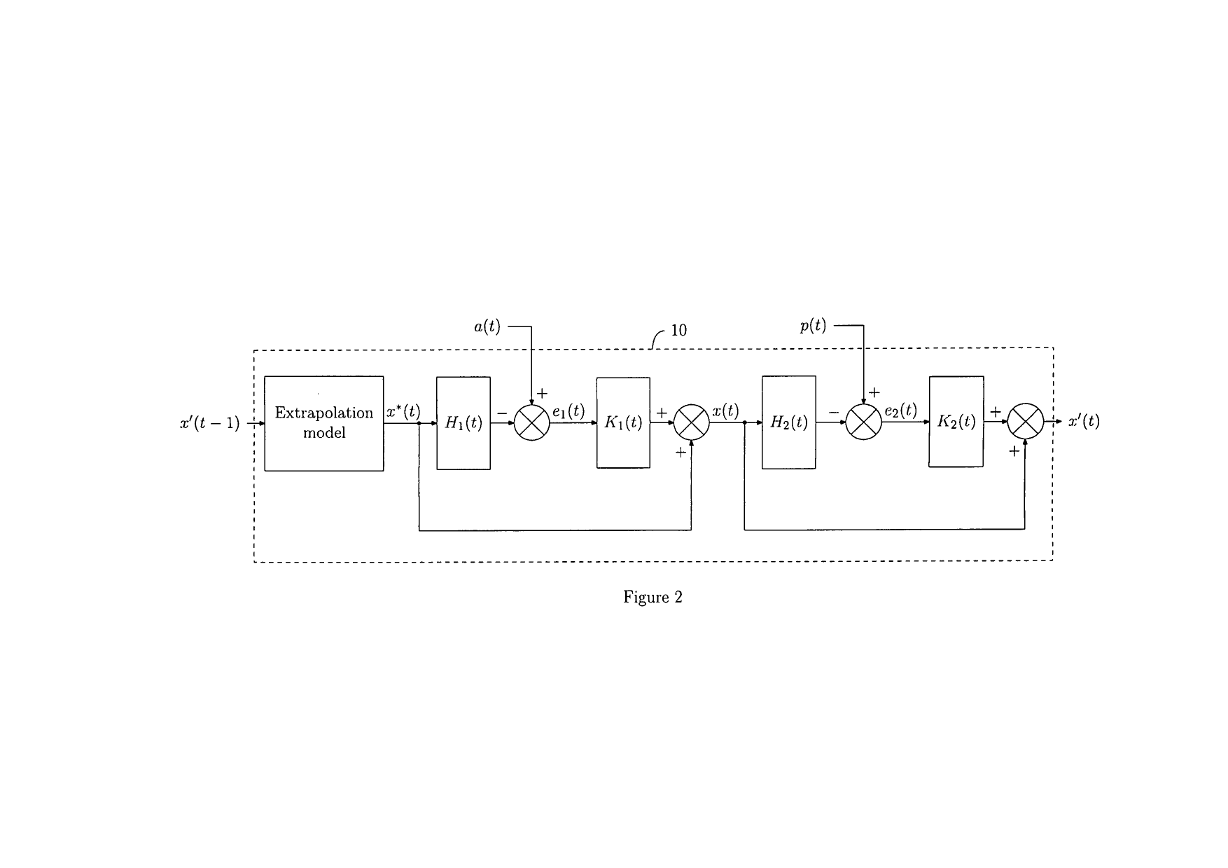

Each step above will now be explained in more detail with reference to FIGS. 2 to 5.

FIG. 2 shows the contents of the aided solution function block 10. Essentially the aided solution function block 10 derives an aided marine vessel state estimate x′(t) (in the form of a vector having at least position and velocity components) by combining together the previous aided marine vessel state estimate x′(t−1) with an acceleration vector a(t) provided by the IMU 2 and a position measurement p(t) provided by the PME 4. It will be readily appreciated that for an iteration of the fault detection method for a time t the acceleration vector that is used will be the buffered acceleration vector a(t−(N+1)) and the position measurement that is used will be the buffered position measurement p(t−(N+1)).

The first input to the aided solution function block 10 is the previous aided marine vessel state estimate x′(t−1). A mathematical model is used to extrapolate this vector forwards to time t producing an uncorrected, extrapolated, vector x*(t). H₁(t) is a mathematical model which extracts a prediction of accelerations and rotations of the marine vessel for comparison with the acceleration vector a(t) provided by the IMU 2. The error e₁(t) between the predicted accelerations and rotations and the acceleration vector a(t) is multiplied by a gain matrix K₁(t) (typically referred to as the Kalman gain matrix) to produce a correction vector, which is added to the extrapolated vector x*(t) to produce an unaided marine vessel state estimate x(t). H₂(t) is a mathematical model which extracts a prediction of the position of the marine vessel for comparison with the position measurement p(t) provided by the PME 4. The error e₂(t) between the predicted position and the position measurement p(t) is multiplied by a gain matrix K₂(t) to produce an additional correction vector, which is added to the unaided marine vessel state estimate x(t) to produce an aided marine vessel state estimate x′(t).

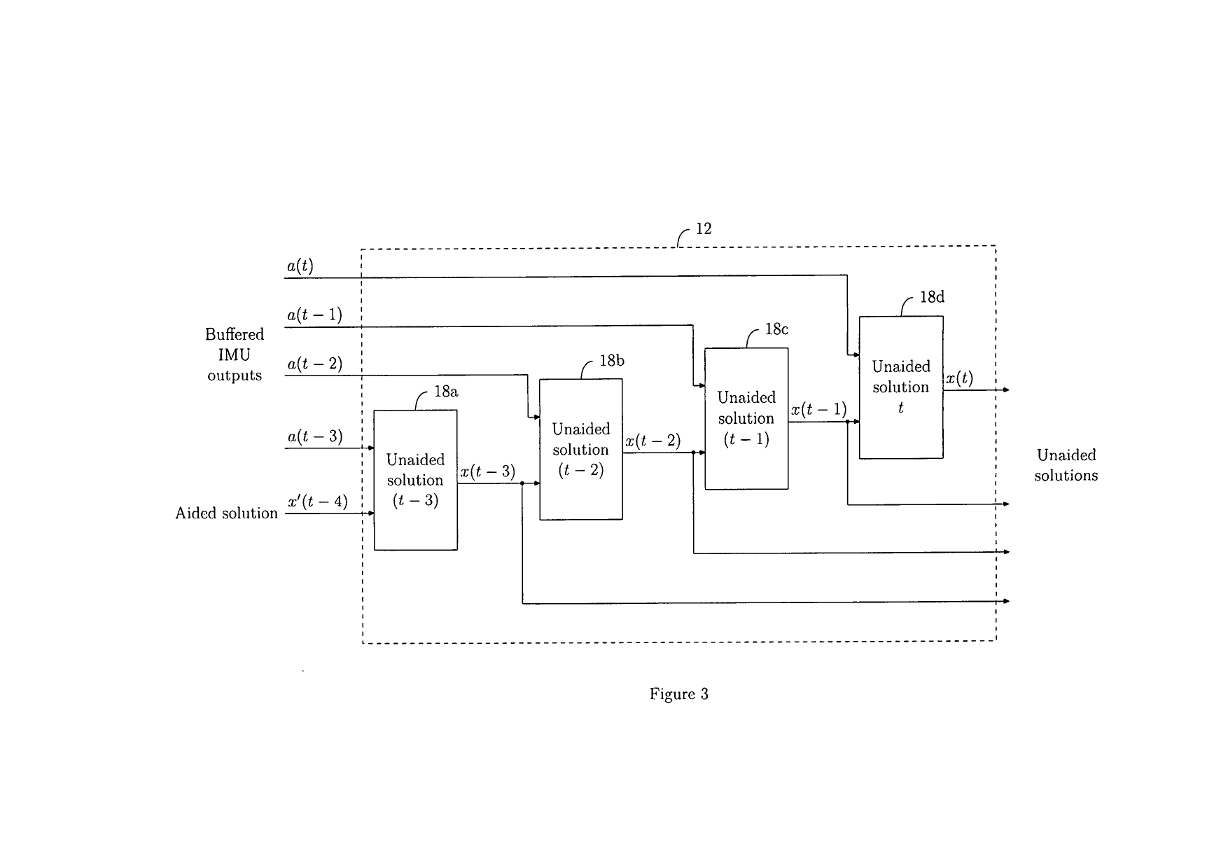

FIG. 3 shows the contents of the unaided solutions function block 12. Essentially the unaided solutions function block 12 derives a series of unaided marine vessel state estimates x(t−N) . . . x(t−1), x(t) (in the form of vector series having at least position and velocity components) from the buffered acceleration vectors a(t−N) . . . a(t−1), a(t) and the previous unaided (or aided) marine vessel state estimate. All of the series of unaided marine vessel state estimates x(t−N) . . . x(t−1), x(t) are derived for each iteration of the fault detection method. In other words, the unaided solutions function block 12 uses all of the buffered acceleration vectors for time t−N to time t during each iteration of the fault detection method and all of the processing to derive the series of unaided marine vessel state estimates x(t−N) . . . x(t−1), x(t) for an iteration at time t is completed before the next iteration at time t+1.

For clarity, FIG. 3 shows a situation where N=3 seconds. The aided marine vessel state estimate x′(t−4) that is derived from the aided solution function block 10 is used as a start condition to a first function block 18a. The aided marine vessel state estimate x′(t−4) is combined with a buffered acceleration vector a(t−3) in the first function block 18a to derive a first unaided marine vessel state estimate x(t−3). The first unaided marine vessel state estimate x(t−3) is combined with a buffered acceleration vector a(t−2) in the second function block 18b to derive a first unaided marine vessel state estimate x(t−2) and so on to provide a series of unaided marine vessel state estimates x(t−3) . . . x(t−1), x(t).

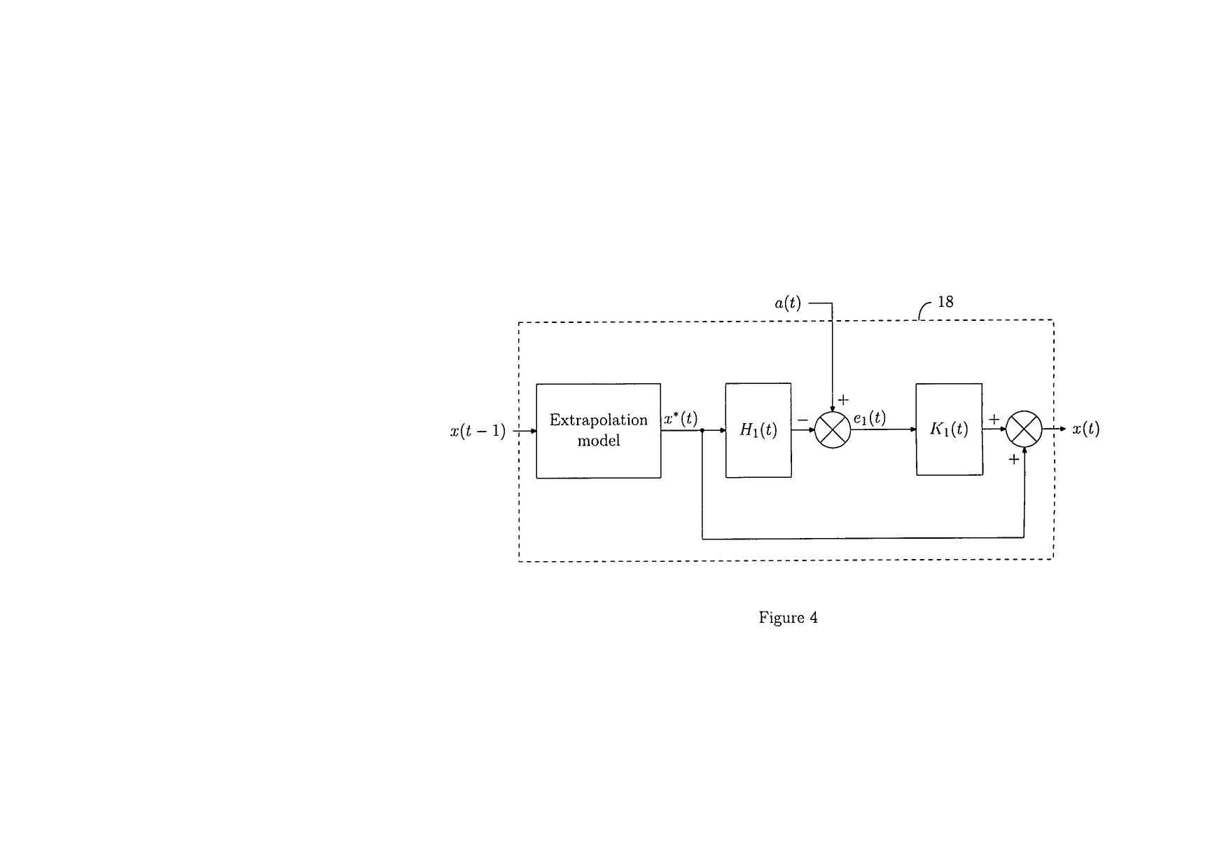

The function blocks 18a to 18d will now be described in more detail with reference to FIG. 4. Essentially each function block 18a to 18d derives an unaided marine vessel state estimate x(t) by combining together the previous unaided marine vessel state estimate x(t−1) (or in the case of the first function block 18a, the previous aided marine vessel state estimate x′(t−1)) with an acceleration vector a(t) provided by the IMU 2. It will be readily appreciated that for an iteration of the fault detection method for a time t the acceleration vector that is used in function block 18a will be the buffered acceleration vector a(t−N), the acceleration vector that is used in function block 18b will be the buffered acceleration vector a(t−(N−1)) and so on. The function block 18a will use as its start condition the aided marine vessel state estimate x′(t−(N+1)) that is provided by the aided solution function block 10 and which in turn is derived for the same iteration of the fault detection method for a time t using the buffered acceleration vector a(t−(N+1)) and the buffered position measurement p(t−(N+1)) as described above.

The first input to the function block 18a is the previous aided marine vessel state estimate x′(t−1) and the first input to each subsequent function block 18b to 18d is the previous unaided marine vessel state estimate x(t−1) derived by the previous function block in the series. A mathematical model is used to extrapolate this vector forwards to time t producing an uncorrected, extrapolated, vector x*(t). H₁(t) is a mathematical model which extracts a prediction of accelerations and rotations of the marine vessel for comparison with the acceleration vector a(t) provided by the IMU 2. The error e₁(t) between the predicted accelerations and rotations and the acceleration vector a(t) is multiplied by a gain matrix K₁(t) to produce a correction vector, which is added to the extrapolated vector x*(t) to produce an unaided marine vessel state estimate x(t).

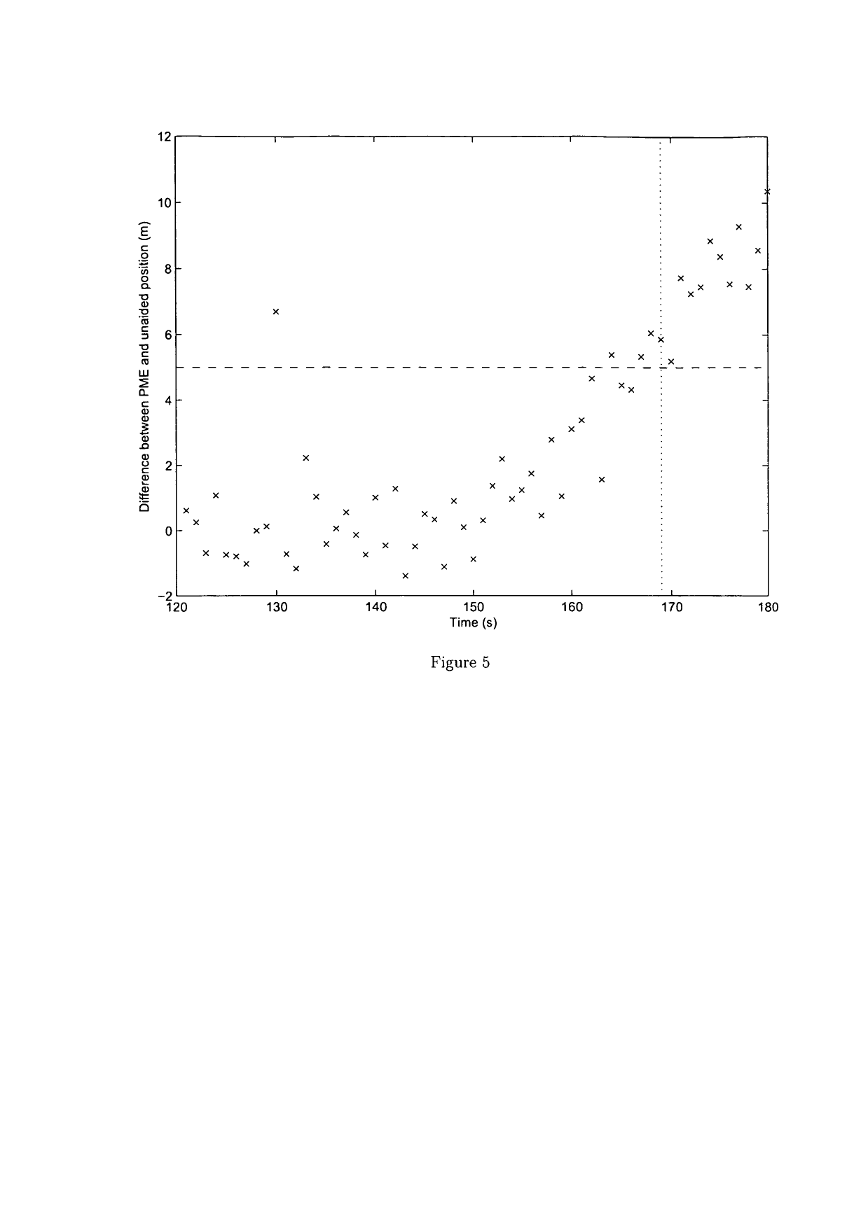

The fault detection method may make use of all or part of the series of unaided marine vessel state estimates or just one of the unaided marine vessel state estimates. An example of the detection of PME drift is shown in FIG. 5. The points marked with a x represent the error between the position measurements provided by the PME 4 and the position components of corresponding unaided marine vessel state estimates for a period of 60 seconds. In this example the PME 4 experiences a fault at time t=150 seconds that causes the position measurements to drift. In this example, only one unaided marine vessel state estimate x(t) is used for each iteration of the fault detection method. In other words, for the time t=120 seconds then the fault detection system will use the buffered acceleration data for the preceding 60 seconds (i.e. for the time t=61 to time t=120) to derive a series of unaided marine vessel state estimates x(t=61) . . . x(t=119), x(t=120) but only the position component of the final unaided marine vessel state estimate x(t=120) is used to determine the error between x(t=120) and the position measurement p(t=120) which is then shown on the graph. The remaining unaided marine vessel state estimates x(t=61) . . . x(t=119) are not used but will, of course, influence the final unaided marine vessel state estimate x(t=120) because of the way in which subsequent unaided marine vessel state estimates are derived with reference to the previous unaided marine vessel state estimate in function blocks 18. The errors shown in FIG. 5 between the position component of the final unaided marine vessel state estimates x(t=121) . . . x(t=180) and the corresponding position measurements p(t=121) . . . p(t=180) are derived in the same way.

The dashed horizontal line represents an error threshold for fault detection (i.e. m=5 metres).

At time t=130 seconds then it can be seen that the error between position measurement p(t=130) provided by the PME 2 and the position component of unaided marine vessel state estimate x(t=130) derived from the unaided solution function block 12 exceeds the error threshold but a fault is not detected.

The dotted vertical line at t=169 seconds represents a detected fault where three consecutive errors provided by the PME 2 have exceeded the error threshold. If a fault is detected then the PME may be isolated from the DP system until it has been checked and repaired.

It will be readily appreciated that other techniques and algorithms for fault detection can be used.

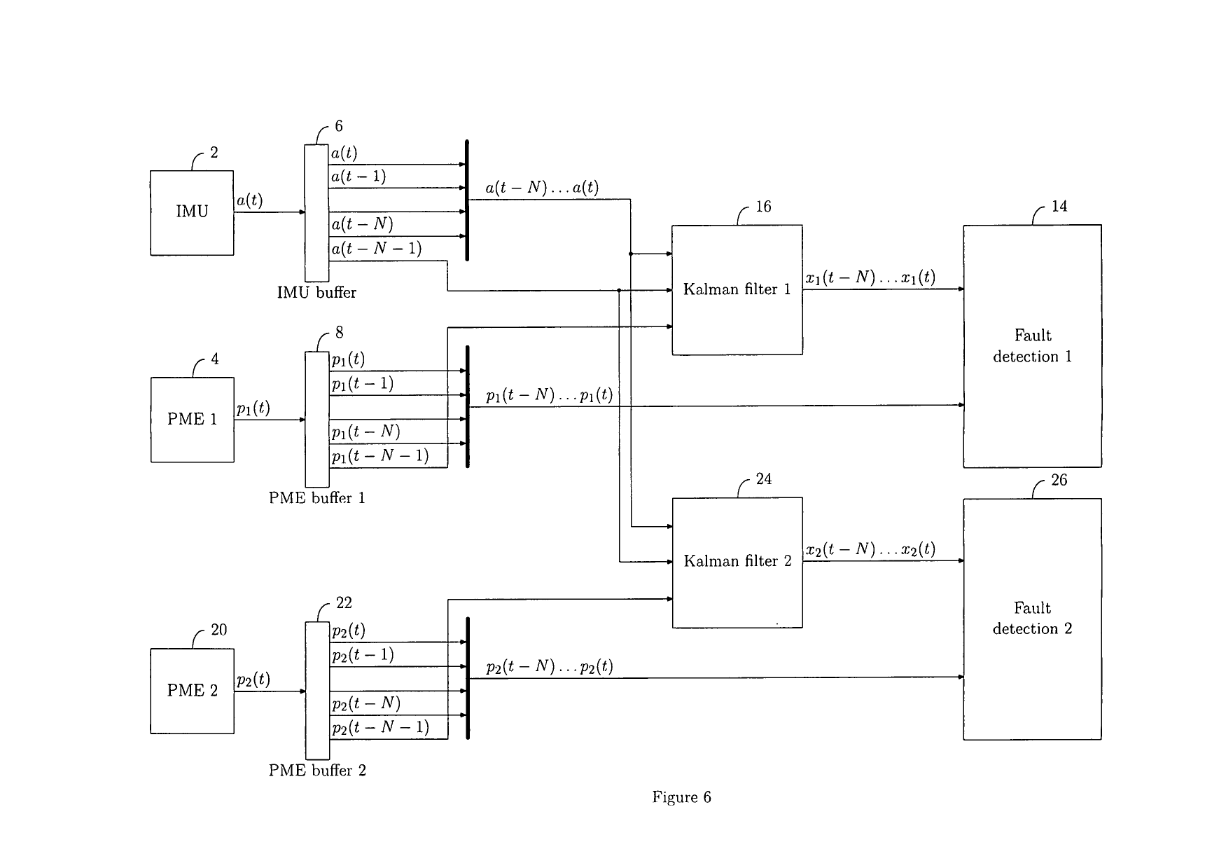

A second fault detection system will now be described with reference to FIG. 6. The second fault detection system is broadly similar to the first fault detection system but includes two separate PME located in parallel.

Position measurements are provided by a first PME 4 and a second PME 20. Position measurements p₁(t) are provided by the first PME 4 and stored in a first PME buffer 8 while position measurements p₂(t) are provided by the second PME 20 and stored in a second PME buffer 22. The position measurements p₁(t) provided by the first PME 4 are used as described above with an aided marine vessel state estimate for an iteration at time t being derived from position measurement p₁(t−(N+1)) in a first Kalman filter 16 and all or part of a series of position measurements p₁(t−N) . . . p₁(t−1), p₁(t) being compared with all or part of a series of unaided marine vessel state estimates x₁(t−N) . . . x₁(t−1), x₁(t) in a first fault detection function block 14.

The position measurements p₂(t) provided by the second PME 20 are used in parallel with an aided marine vessel state estimate for an iteration at time t being derived from position measurement p₂(t−(N+1)) in a second Kalman filter 24 and all or part of a series of position measurements p₂(t−N) . . . p₂(t−1), p₂(t) being compared with all or part of a series of unaided marine vessel state estimates x₂(t−N) . . . x₂(t−1), x₂(t) in a second fault detection function block 26. Such a fault detection system derives separate aided and unaided marine vessel state estimates for each PME in parallel using the same inertial measurements from the IMU 2 and is therefore capable of identifying faults independently in either PME.

Although FIG. 6 shows two PME it will be readily appreciated that any number of PME can be connected together in parallel together with an associated PME buffer, Kalman filter and fault detection function block.

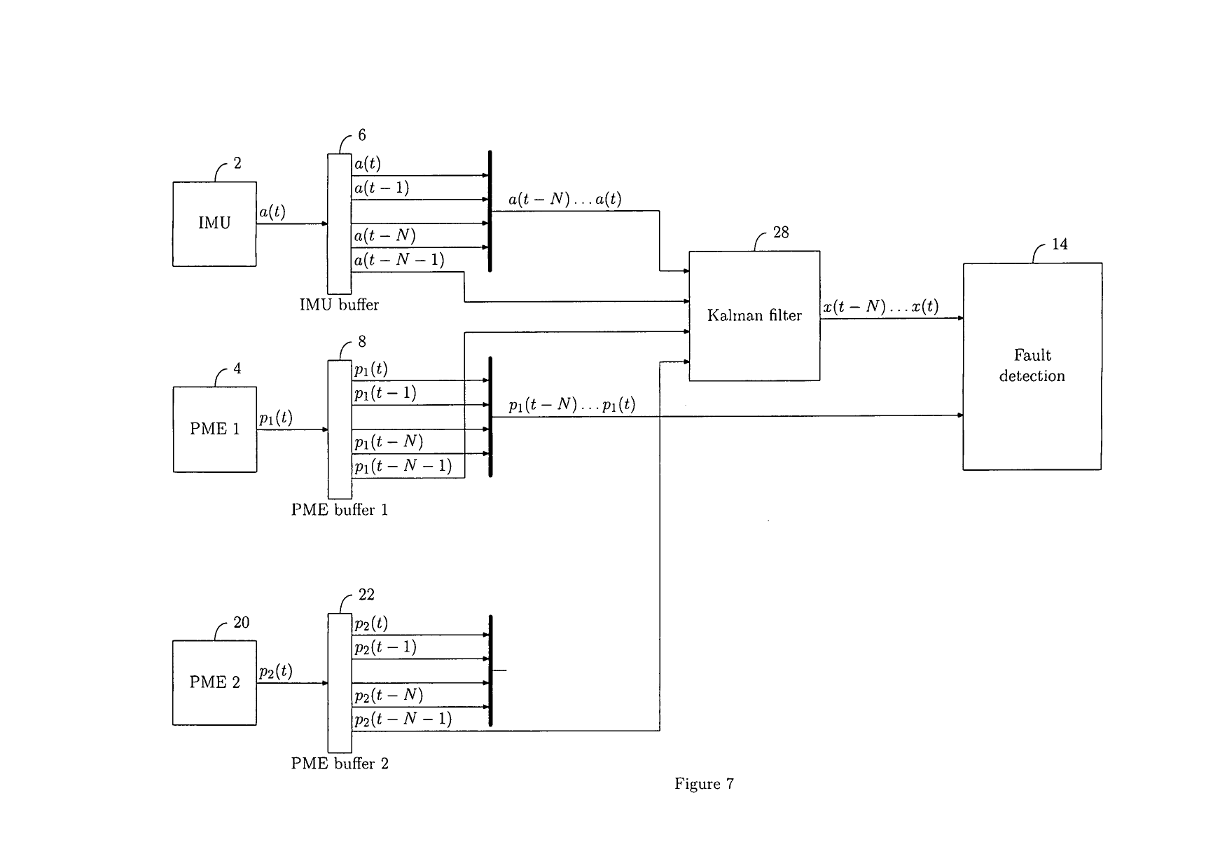

A third fault detection system will now be described with reference to FIG. 7. The second fault detection system is broadly similar to the first fault detection system but includes two separate PME that both provide position measurements for the purpose of deriving the aided marine vessel state estimates.

The position measurements p₁(t) provided by the first PME 4 are used as described above with an aided marine vessel state estimate for an iteration at time t being derived from position measurement p₁(t−(N+1)) in the Kalman filter 28 and compared with all or part of a series of unaided marine vessel state estimates x(t−N) . . . x(t−1), x(t) in the fault detection function block 14. However, the aided marine vessel state estimate for the iteration at time t is also derived from position measurement p₂(t−(N+1)) provided by the second PME 20. The subsequent position measurements p₂(t−N) . . . p₂(t−1), p₂(t) are buffered but are not used by the fault detection method. As a result, only a fault in the first PME 4 can be detected by the third fault detection system. The buffered position measurements p₂(t−N) . . . p₂(t−1), p₂(t) may be used by the DP system, for example.

With reference to FIG. 2 then the position measurements p₁(t) and p₂(t) provided by the first and second PME can be combined (e.g. to provide a weighted combination or average) which is then used to derive the error e₂(t).

In an alternative arrangement, a switch array can be used to select one or both of the position measurements p₁(t) and p₂(t) to derive the aided marine vessel state estimate. Although FIG. 7 shows two PME it will be readily appreciated that the position measurements from any number of PME can be used to derive each aided marine vessel state estimate. A switch array (not shown) can be used to select one or more of the available position measurements to derive the aided marine vessel state estimate in the Kalman filter 28. If two or more position measurements are selected then they can be combined (e.g. to provide a weighted combination or average) as described above.

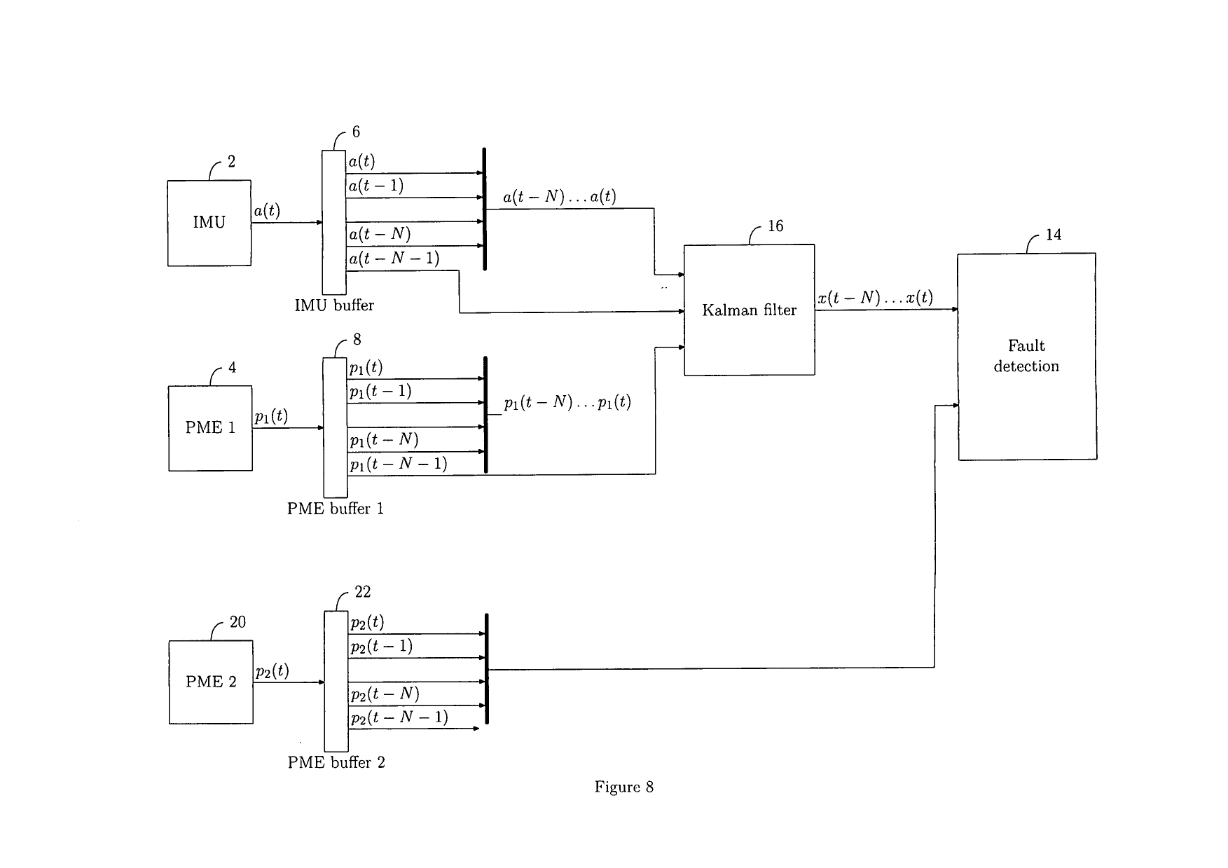

A fourth fault detection system will now be described with reference to FIG. 8. The fourth fault detection system is broadly similar to the third fault detection system but the position measurements provided by one PME are used for the purpose of deriving the aided marine vessel state estimates while the position measurements provided by another PME are used for fault detection. In other words, in the third fault detection system at least one PME provides position measurements that are used both for the purpose of deriving the aided marine vessel state estimates and for fault detection, but in the fourth fault detection system the PME that is being checked for faults does not provide the position measurements that are used to derive the aided marine vessel state estimates.

The position measurements p₁(t) provided by the first PME 4 are used as described above with an aided marine vessel state estimate for an iteration at time t being derived from position measurement p₁(t−(N+1)) in the Kalman filter 16. However, the position measurements p₁(t) are not provided to the fault detection function block 14. The subsequent position measurements p₁(t−N) . . . p₁(t−1), p₁(t) are buffered but are not used by the fault detection method. The buffered position measurements p₁(t−N) . . . p₁(t−1), p₁(t) may be used by the DP system, for example.

The position measurements p₂(t) provided by the second PME 20 are stored in the PME buffer 22. All or part of the series of position measurement p₂(t−N) . . . p₂(t−1), p₂(t) are then supplied to the fault detection function block 14 and are compared with all or part of a series of unaided marine vessel state estimates x(t−N) . . . x(t−1), x(t) that is derived using the aided marine vessel state estimate and the series of acceleration vectors a(t−N) . . . a(t−1), a(t) provided by the IMU 2. As a result, only a fault in the second PME 20 can be detected by the fourth fault detection system.

The second, third and fourth fault detection systems can be used in combination with the position measurements from one or more PME being used to derive the aided marine vessel state estimate but with the option to detect faults in one or more PME. In this case one or more switch arrays can also be used to determine which position measurements are used to derive the aided marine vessel state estimates and which of the buffered position measurements are provided to a fault detection function block to be used for fault detection purposes.

What is claimed is:

1. A method of using inertial measurements provided by an inertial measurement unit to detect a fault in position measurement equipment associated with a marine vessel and providing position measurements and/or velocity measurements, the method comprising the steps of:
using an earlier inertial measurement a(t−(N+1) and one or both of an earlier position measurement p(t−(N+1) and an earlier velocity measurement to derive an aided marine vessel state estimate x′(t−N+1);
using at least one inertial measurement a(t−N) . . . a(t) and the aided marine vessel state estimate x′(t−(N+1)) as a start condition to derive at least one unaided marine vessel state estimate x(t−N) . . . x(t); and
comparing the at least one unaided marine vessel state estimate x(t−N) . . . x(t) with at least one position measurement p(t−N) . . . p(t) and/or at least one velocity measurement provided by the position measurement equipment to determine if there is a fault in the position measurement equipment.

2. A method according to claim 1, wherein inertial measurements a(t−N) . . . a(t) provided by the inertial measurement unit are stored in a buffer.

3. A method according to claim 1, wherein position measurements p(t−N) . . . p(t) and/or velocity measurements provided by the position measurement equipment are stored in a buffer.

4. A method according to claim 1, wherein the steps of deriving the aided marine vessel state estimate x′(t−(N+1)) for a time t−(N+1) and the at least one unaided marine vessel state estimate x(t−N) . . . x(t) for time t further comprise the steps of:
(i) deriving an aided marine vessel state estimate x′(t−(N+1)) for time t−(N+1) from an inertial measurement a(t−(N+1)) for time t−(N+1) and one or both of a position measurement p(t−(N+1)) and a velocity measurement for time t−(N+1); and
(ii) using the aided marine vessel state estimate x′(t−(N+1)) for time t−(N+1) as a start condition to a process that derives the at least one unaided marine vessel state estimate x(t−N) . . . x(t) from stored inertial measurements a(t−N) . . . a(t) for time t−N to time t.

5. A method according to claim 1, wherein a series of stored inertial measurements a(t−N) . . . a(t) are used to derive one unaided marine vessel state estimate x(t) for time t which is compared with one position measurement p(t) and/or one velocity measurement for time t to determine if there is a fault in the position measurement equipment.

6. A method according to claim 1, wherein a series of stored inertial measurements a(t−N) . . . a(t) are used to derive, a series of unaided marine vessel state estimates x(t−N) . . . x(t) for time t−N to time t and where all or part of the series of unaided marine vessel state estimates x(t−N) . . . x(t) is compared with all or part of a series of stored position measurements p(t−N) . . . p(t) and/or a series of stored velocity measurements for time t−N to time t to determine if there is a fault in the position measurement equipment.

7. A method according to claim 1, wherein the at least one unaided marine vessel state estimate x(t−N) . . . x(t) is derived using a recursive algorithm.

8. A method according to claim 1, wherein the aided marine vessel state estimate x′(t−(N+1)) is derived using a recursive algorithm.

9. A method according to claim 7, wherein the recursive algorithm is a Kalman filter.

10. A method according to claim 1 with a plurality of position measurement equipment associated with the marine vessel each providing position measurements and/or velocity measurements, wherein the step of deriving the aided marine vessel state estimate x′(t−(N+1)) uses one or both of an earlier position measurement p₁(t−(N+1)), p₂(t−(N+1)) and/or an earlier velocity measurement provided by at least one of the plurality of position measurement equipment.

11. A method according to claim 1 with a plurality of position measurement equipment associated with the marine vessel each providing position measurements and/or velocity measurements, wherein the step of deriving the aided marine vessel state estimate x′(t−(N+1)) for time t−(N+1) uses one or both of a position measurement p₁(t−(N+1)), p₂(t−(N+1)) and/or an earlier velocity measurement for time t−(N+1) provided by at least one of the plurality of position measurement equipment.

12. A method according to claim 10, wherein position measurements p₁(t−(N+1)), p₂(t−(N+1)) and/or velocity measurements from two or more of the plurality of position measurement equipment are combined together and used to derive the aided marine vessel state estimate x′(t−(N+1)).

13. A method according to claim 10, wherein the at least one unaided marine vessel state estimate x(t−N) . . . x(t) is compared with at least one position measurement p₁(t−N) . . . p₁(t), p₂(t−N) . . . p₂(t) and/or at least one velocity measurement provided by at least another one of the position measurement equipment to determine if there is a fault in said at least another one of the position measurement equipment.

14. A fault detection system comprising:
an inertial measurement unit providing inertial measurements a(t−N) . . . a(t);
at least one position measurement equipment associated with a marine vessel and providing position measurements p(t−N) . . . p(t) and/or velocity measurements;
means for deriving an aided marine vessel state estimate x′(t−(N+1)) using an earlier inertial measurement a(t−(N+1)) and one or both of an earlier position measurement p(t−(N+1)) and an earlier velocity measurement;
means for deriving at least one unaided marine vessel state estimate x(t−N) . . . x(t) using at least one inertial measurement a(t−N) . . . a(t) and the aided marine vessel state estimate x′(t−(N+1)) as a start condition; and
means for comparing the at least one unaided marine vessel state estimate x(t−N) . . . x(t) with at least one position measurement p(t−N) . . . p(t) and/or at least one velocity measurement provided by the position measurement equipment to determine if there is a fault in the position measurement equipment.

15. A fault detection system according to claim 14, further comprising a buffer for storing inertial measurements a(t−N) . . . a(t) provided by the inertial measurement unit.

16. A fault detection system according to claim 14, further comprising a buffer for storing position measurements p(t−N) . . . p(t) and/or velocity measurements provided by the position measurement equipment-(4).

17. A fault detection system according to claim 14, wherein the means for deriving the aided marine vessel state estimate x′(t−(N+1)) is a Kalman filter.

18. A fault detection system according to claim 14, wherein the means for deriving the at least one unaided marine vessel state estimate x(t−N) . . . x(t) is a Kalman filter.

19. A fault detection system according to claim 15, further comprising a buffer for storing position measurements p(t−N) . . . p(t) and/or velocity measurements provided by the position measurement equipment.

20. A method according to claim 8, wherein the recursive algorithm is a Kalman filter.

21. A method according to claim 11, wherein position measurements p₁(t−(N+1)), p₂(t−(N+1)) and/or velocity measurements from two or more of the plurality of position measurement equipment are combined together and used to derive the aided marine vessel state estimate x′(t−(N+1)).

22. A method according to claim 11, wherein the at least one unaided marine vessel state estimate x(t−N) . . . x(t) is compared with at least one position measurement p₁(t−N) . . . p₁(t), p₂(t−N) . . . p₂(t) and/or at least one velocity measurement provided by at least another one of the position measurement equipment to determine if there is a fault in said at least another one of the position measurement equipment.
